(19) United States
(12) Patent Application Publication
(10) Pub. No.: US 2002/0021015 A1
(43) Pub. Date: Feb. 21, 2002

(54) Self adjusting length battery retaining strap for interior mounted underseat vehicular batteries

(76) Inventors: Walter J. Kronner, Sterling Heights, MI (US); Ernst Von Schlager, Novi, MI (US); Jeffry J. Chisholm, Lake Orion, MI (US); Kevin E. Keas, Detroit, MI (US); James E. Van Hout, Auburn Hills, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 09/795,590

(22) Filed: Feb. 28, 2001

Related U.S. Application Data
(63) Continuation-in-part of application No. 09/625,557, filed on Jul. 25, 2000, now Pat. No. 6,264,260.

(51) Int. Cl. B60N 3/12

(52) U.S. Cl. 296/37.15

(57) ABSTRACT

A storage compartment mounted to the floor of a motor vehicle under a seat. The compartment is for storing vehicle components such as car batteries. The compartment includes an opening secured by a strap and the strap is held in place by a removable fastener. The strap being formed of a deformable material that may stretch over a range of lengths and yet still maintain a consistent restraining force on a component.

### CROSS-REFERENCE TO RELATED APPLICATION

This is a continuation-in-part of U.S. Ser. No. 09/625,557 filed Jul. 25, 2000.

### FIELD OF THE INVENTION

The present invention relates generally to vehicular component storage, and more particularly to storage of motor vehicle components under at least one seat in the passenger compartment.

### BACKGROUND

Modern motor vehicles have a multitude of components that must be assembled and stored in the vehicle. A problem that has arisen in many modern vehicles is that to minimize overall body size and to increase vehicle features the space in the engine compartment has become premium. This being the case, there has been a movement to place some components that had been previously mounted in the engine compartment in the passenger compartment. The areas most conducive to such storage within the passenger compartment are the areas below the passenger seats. If components are not mounted here then the area below the seats often goes unutilized or under utilized.

There have been a few designs for under seat compartments, but they have often required the removal of the seats to service the stored components. The removal of the seats has become disadvantageous as more features are added to vehicle seats. Seats with more features generally have more electronics routed through them so that owner removal of the seats is unwanted. Therefore, the old storage compartments that require the removal of the seats to service the stored components are no longer advantageous.

Consequently, storage compartments under the seats must allow access through side doors so that the stored component may be slid out from under the seat. Thus a solid, or unmovable, storage area must contain a door that is secured to contain the vehicle component. Therefore, it is desirable to provide the storage compartment with a closure strap that may receive several different size components without requiring a unique compartment or a unique closure strap for each component.

### SUMMARY OF THE INVENTION

According to the invention, a storage compartment is mounted to the vehicle floor under at least one seat in the vehicle. The compartment further comprises an opening that is secured by a strap that is hingedly attached to the remainder of the compartment so that the strap may be moved to allow access to the component stored within the storage compartment. The strap is secured by a removable fastener that is generally installed to secure the opening to the storage compartment.

The strap of the present invention is formed from a material or with a material having a particular form factor so as to allow it to stretch. The stretching of the strap allows a single compartment to receive several different component sizes without requiring a uniquely designed compartment for each different component. The strap may include several forms which may include an elastic type strap or one having an accordion form factor. The forms would allow for a single strap design to hold several differently sized components with the same force.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a transparent side view of a motor vehicle with a car battery having been placed under a front seat.

FIG. 2 is a schematic view of a seat bottom having a component storage unit having a car battery placed within it.

FIG. 3 is a schematic view of the component storage unit.

FIG. 3a is a schematic view of a second embodiment of the component storage unit according to the present invention.

FIG. 4 is a schematic view of the component storage unit in its open position and the direction of the car battery's movement to be serviced.

FIG. 5 shows the seat bottom and the installed and uninstalled position of the car battery.

FIG. 6 shows a car battery installed in the component storage unit and the opening strap in its contracted form.

FIG. 7 shows a car battery installed in the component storage unit with the strap in its extended position.

### DETAILED DESCRIPTION OF THE PREFERRED EMBODIMENTS

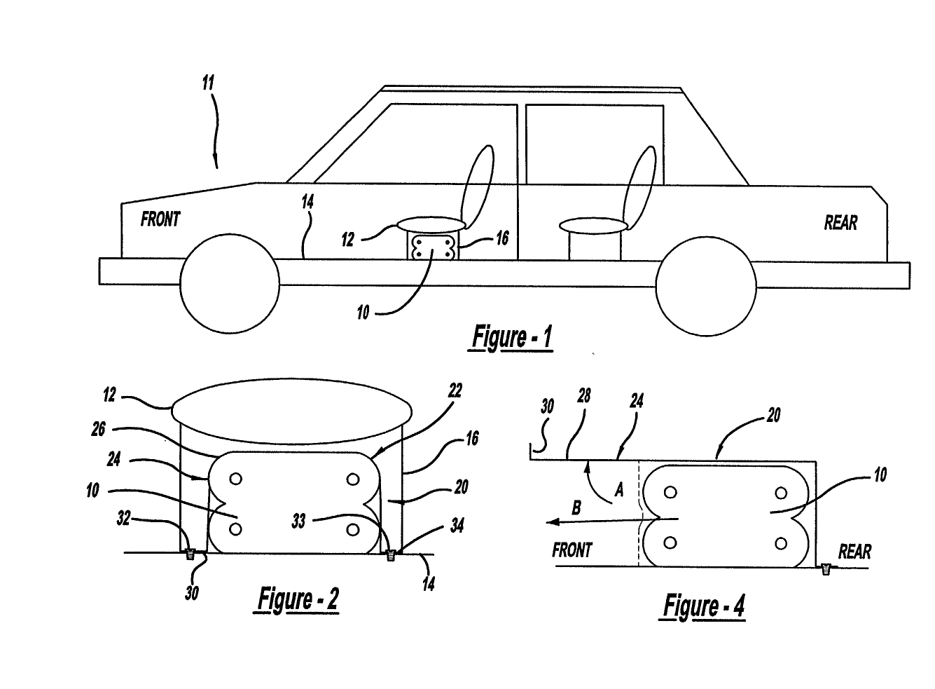

With reference to FIG. 1, a possible placement of a vehicle component, here a battery 10, is placed within a vehicle 11 below a vehicle seat 12 and resting on the vehicle floor 14. The battery 10 may be loaded vertically into place before the seat 12 is installed into the vehicle 11. The battery 10 or other component can be stored within the plurality of supports 16 of the vehicle seat 12. This space could otherwise be unutilized or underutilized within the vehicle 11. However, the battery 10 must be secured to ensure retention of the battery 10. Also the system for securing the battery 10 should allow for ease of service access.

With reference to FIG. 2, a component retention system 20 constructed in accordance with the present invention and operative for securing the battery 10 in place so that it can not move once properly installed is positioned beneath a vehicle seat 12. The component retention system 20 includes a main body strap 22, a strap 24 for opening the component retention system 20 and a hinge area 26 which hingedly attaches the strap 24 and allows for ease of entry into the component retention system 20.

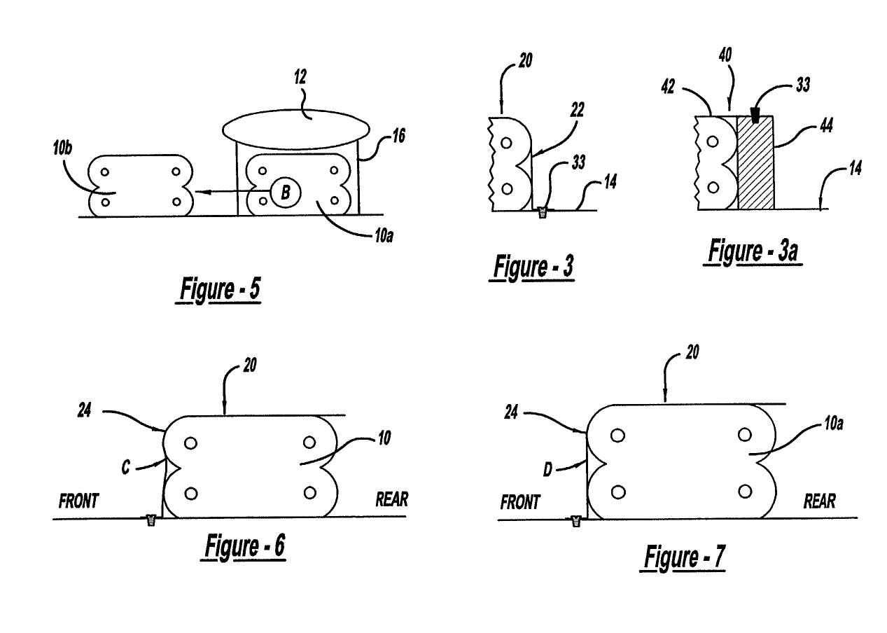

With continuing reference to FIG. 2 and further reference to FIG. 3, the component retention system 20 in which the component may be placed is indicated. It can be seen that the strap 24 has a first part 28 which is the main portion of the strap 24 and a second part, a flange 30 that extends essentially perpendicular to the main portion 28 of the strap 24. A removable fastener 32 fits through an opening in the flange 30 which secures the strap 24 in its closed position. The fastener 32 is secured to the floor 14 of the vehicle 11. A second fastener 33 secures a second flange 34 of the main body strap 22 to the floor 14 of the vehicle 11.

Turning reference to FIG. 3a and continuing reference to FIG. 2 a second embodiment of the presently disclosed invention where like numerals indicate like parts. The component retention system 40 continues to include a strap 24, also, a fastener 32 secures the strap 24 to the floor 14 of the vehicle 11, although not shown here. However, the main body portion 42 of the second embodiment does not continue to the floor 14 of the vehicle 11. Rather, a second fastener 33 secures the second of the main body strap 42 to a pillar 44 which is affixed to the floor 14 of the vehicle 11. The pillar 44 may be any structure of the vehicle including one of the supports 16 of the seat 12 or any other fixed portion of the vehicle 11 which may be at the rear portion of the seat 12. However, these are to be seen as exemplary only and both the straps may be affixed by other means also the main body strap 22 may be affixed to any relatively permanent portion of the vehicle 11.

With reference to FIG. 4, the component retention system 20 with the strap 24 moved in the direction of Arrow A, from the first position shown in broken lines, to the opened position, shown in solid line. When the strap 24 is in this position the battery 10 may be translated laterally in the direction of Arrow B to remove it from the component retention system 20. The strap 24 may be oriented in a front-rear direction under the seat 12 as long as there is adequate room to remove the battery 10. This allows the battery 10 to be easily serviced after it has been installed under the seat 12. Now with reference to FIG. 5, the battery 10 may be moved from its first installed 10a position to a second uninstalled/service position 10b. This entire process is completed without disturbing the seat 12 and any electronics that may be attached to such seat 12.

The battery 10 is installed below the seat 12 by placing the battery 10 within the retention system 20. The strap 24 is then positioned so that the flange 30 is affixed to the floor 14 with a fastener 32. During removal, the fastener 32 is released and the strap 24 is lifted upward as shown in FIG. 4. However, with reference to FIG. 6, it may be seen that the strap 24 is made of an elastic material or in an accordion-like design. In this way if the battery is of smaller stature the strap 24 may bend areas C, but still retain sufficient holding force upon the battery 10 to keep it in place. Likewise, with reference to FIG. 7, the very same strap 24 may be stretched taught, thus not incurring any bending D, yet still safely retain a larger battery 10a. In this way a single component storage strap 24 need be manufactured, yet it is able to retain several different sizes of batteries 10. Thus, the single strap may be included in various automobiles, rather than requiring an individual part for each vehicle 11 that has a different size battery 10 or 10a.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A restraint system for vehicular components comprising:
a storage compartment having an opening on one side thereof for receiving components:
a closure member attached to said one side of said storage compartment which can move from a first generally horizontal open position to a second generally vertical closed position, wherein said closure member is formed of a deformable material so as to receive several differently sized of said components; and
a restraining member for engaging said closure member when said closure member is in said second generally vertical closed position.

2. The restraint system as in claim 1, wherein said closure member has a main body and a flange extending generally perpendicular to an end portion of said main body, wherein said restraining member is captured in said flange.

3. The restraint system as in claim 2, wherein said closure member is constructed of a elastically deformable material.

4. The restraint system as in claim 2, wherein said closure member is constructed of an elastic material.

5. The restraint system as in claim 2, wherein said closure member is constructed of a material having an accordion like form factor.

6. A motor vehicle fitted with a restraining system for interior mounted vehicular components comprising:
a vehicle body;
at least one seat mounted in said vehicle body, defining a storage compartment having an opening on one side thereof for receiving components;
a closure member attached to said one side of said storage compartment which can move from a first generally horizontal open position to a second generally vertical closed position, wherein said closure member is formed of a deformable material so as to receive differently sized of said components; and
a restraining member for engaging said closure member when said closure member is in said second generally vertical closed position.

7. The motor vehicle according to claim 6, wherein said closure member has a main body and a flange extending generally perpendicular to an end of said main body, wherein said restraining member engages said flange.

8. The motor vehicle according to claim 7, wherein said closure member is constructed of an elastically deformable material.

9. The motor vehicle according to claim 8, wherein said storage compartment includes a main body strap includes a hinge for supporting said closure member.

10. The motor vehicle according to claim 9, wherein said main body strap is made from a deformable material.

11. The restraint system as in claim 8, wherein said closure member is constructed of an elastic material.

12. The restraint system as in claim 8, wherein said closure member is constructed of a material having an accordion like form factor.
